(19) United States
(12) Patent Application Publication
(10) Pub. No.: US 2014/0203111 A1
(43) Pub. Date: Jul. 24, 2014

(54) FUEL INJECTION SYSTEM HAVING A FUEL-CARRYING COMPONENT, A FUEL INJECTOR AND A CONNECTING ELEMENT

(71) Applicants: Michael FISCHER, Niefern-Oeschelbronn (DE); Michael KNORPP, Weissach (DE); Martin RIEMER, Untergruppenbach (DE); Hans-Georg HORST, Leonberg (DE); Andreas GLASER, Stuttgart (DE); Philipp ROGLER, Stuttgart (DE); Jan HERRMANN, Stuttgart (DE); Andreas REHWALD, Bietigheim-Bissingen (DE); Michael MAYER, Wannweil (DE); Volker SCHEEF, Ludwigsburg (DE); Wilhelm REINHARDT, Oetisheim (DE)

(72) Inventors: Michael FISCHER, Niefern-Oeschelbronn (DE); Michael KNORPP, Weissach (DE); Martin RIEMER, Untergruppenbach (DE); Hans-Georg HORST, Leonberg (DE); Andreas GLASER, Stuttgart (DE); Philipp ROGLER, Stuttgart (DE); Jan HERRMANN, Stuttgart (DE); Andreas REHWALD, Bietigheim-Bissingen (DE); Michael MAYER, Wannweil (DE); Volker SCHEEF, Ludwigsburg (DE); Wilhelm REINHARDT, Oetisheim (DE)

(73) Assignee: ROBERT BOSCH GMBH, Stuttgart (DE)

(21) Appl. No.: 14/159,712

(22) Filed: Jan. 21, 2014

(30) Foreign Application Priority Data
Jan. 18, 2013 (DE) 10 2013 200 719.1

(51) Int. Cl. F02M 55/00

(52) U.S. Cl. CPC F02M 55/005
USPC 239/584; 285/305

(57) ABSTRACT

A connecting element for fuel injection systems is used for connecting a fuel injector to a fuel-carrying component. For this purpose, the connecting element has a base body, which is connected on the one side in a form-locking manner to the fuel-carrying component and on the other side is connected in a form-locking manner to the fuel injector. The base body is developed as a bracket-shaped base body, the base body having a first arm, a second arm and a connecting web. The base body abuts on a first contact surface, which is provided on the first arm, on the one side against the fuel-carrying component and on a second contact surface, which is provided on the second arm, on the other side against the fuel injector. An elastic decoupling is provided between the first contact surface and the second contact surface. Furthermore, a fuel injection system having a fuel-carrying component, a fuel injector and such a connecting element is indicated.

### FIELD OF THE INVENTION

The present invention relates to a connecting element for fuel injection systems for connecting a fuel injector to a fuel-carrying component, and it relates to a fuel injection system having such a connecting element. The present invention specifically relates to the field of fuel injection systems for mixture-compressing internal combustion engines having externally supplied ignition.

### BACKGROUND INFORMATION

German Published Patent Application No. 10 2005 020 380 describes a fuel injection device, which is characterized by a noise-decoupling construction. The known fuel injection device includes a fuel injector, a receiving borehole for the fuel injector in a cylinder head and a fuel distributor line having a connection fitting, into which the fuel injector is inserted in a partially overlapping manner. In one possible development, a connecting part is developed as a pot-shaped sleeve, which is situated securely and solidly on the downstream end of the connection fitting. The connecting part is developed in two parts, that is to say, it is made up of two semiannular ring elements. Each of the ring elements has a jacket section and a bottom section, the jacket section opposite the bottom section respectively transitioning into a hook-shaped latching section. The latching sections of the connecting part engage into two grooves on the circumference of the connection fitting. A middle opening is provided in the bottom section, through which a tapered region of the fuel injector penetrates, the tapered region having a conical edge as contact surface on the inflow fitting.

The development of the fuel injection device known from German Published Patent Application No. 10 2005 020 380 has the disadvantage that vibrations may be transmitted from the fuel injector to the connection fitting via the connecting part that is developed as a pot-shaped sleeve. In particular, structure-borne noise may be transmitted as a result via the connecting part. This worsens a noise behavior.

Specifically in the case of electromagnetic high-pressure fuel injectors, which may be used in Otto engines having direct injection, an obtrusive and disturbing contribution to the overall noise of the engine may occur, which may be described as valve ticking. Such valve ticking arises from the rapid opening and closing of the fuel injector, in which the valve needle is displaced in a highly dynamic way to the respective end stops. The impact of the valve needle on the end stops results in brief but very high contact forces which are transferred via a housing of the fuel injector to a fuel distributor rail or the like in the form of structure-borne noise and vibrations. This results in a great noise generation.

### SUMMARY

The connecting element according to the present invention and the fuel injection system according to the present invention have the advantage that an improved connection of the fuel injector to the fuel-carrying component is made possible, a noise reduction being achieved in the process. In particular a soft connection of the fuel injector to the fuel-carrying component may be achieved.

The connecting element and the fuel injection system are especially suitable for direct fuel injection in motor vehicles. The fuel-carrying component is preferably developed in this instance as a fuel distributor, especially a fuel distributor rail. On the one hand, such a fuel distributor may be used for distributing the fuel to a plurality of fuel injectors, especially high-pressure fuel injectors. On the other hand, the fuel distributor may be used as a common fuel store for the fuel injectors. The fuel injectors are then preferably connected to the fuel distributor via corresponding connecting elements. In a modified development, the fuel-carrying component may also be a fuel line, by which the fuel injector is connected via the connecting element.

The fuel-carrying component and the fuel injector are not component parts of the connecting element according to the present invention. In particular, the connecting element according to the present invention may also be manufactured and marketed separately from the fuel-carrying component as well as from a fuel injector. Nevertheless, the connecting element may be a component part of a fuel-carrying component, in particular of a fuel distributor.

The connecting element may be used advantageously to attach the fuel injector to a fuel distributor, it being possible to eliminate the structure-borne noise path to a cylinder head with the exception of a Teflon ring or the like. A decoupling between the fuel injector and the fuel distributor is also ensured in this instance. Using the connecting element, it is thus possible to implement an effective decoupling in a compact construction and thus at a low space requirement. A required decoupling stiffness and a required stability, which are relevant in particular in the case of high system pressures, may thus be ensured over the service life. Depending on the respective application, a connection of the fuel injector to the fuel-carrying component may also be implemented via multiple connecting elements.

The soft coupling of the fuel injector to the fuel-carrying component may occur in particular at a target stiffness of no more than 50 kN/mm, it being possible to fulfill the stability requirements over the service life. In this instance, the fuel injector is fastened to the fuel-carrying component via at least one connecting element. With regard to the desired target stiffness, the number of connecting elements, which are used to connect a fuel injector to the fuel-carrying component, may be readily taken into account.

The advantage of such a soft attachment lies in a clear reduction of the transmitted structure-borne noise and the associated reduction of the noise of the fuel injection system. Furthermore, this measure reinforces other noise-reducing measures, which may be implemented additionally. For example, a hydraulic throttle may be additionally provided on a valve inlet to the fuel injector and a soft screw connection may be additionally provided on the fuel distributor rail.

Another advantage is a simple installation of the connecting element. In particular, no pre-assembly of the connecting element on the fuel injector or the fuel-carrying component is required. In particular, the fuel injector may first be placed on the fuel-carrying component and then the connecting element may be suitably attached.

It is advantageous for the base body to have a connecting web and for the first arm and the second arm to be connected to each other via the connecting web. It is furthermore advantageous in this regard that at least the first arm of the base body and/or at least the second arm of the base body and/or at least the connecting web of the base body is/are formed at least partially from an elastic material. Specifically, the entire base body may be formed at least partially from an elastic material. This makes it possible to implement a decoupling between the first contact surface and the second contact surface, it being possible to specify the desired stiffness in a targeted manner.

It is furthermore advantageous in this regard that at least the first arm of the base body and/or at least the second arm of the base body and/or at least the connecting web of the base body is/are formed from multiple layers, a portion of the layers being formed from an elastic material. The other portion of the layers may be formed from a metallic material. This makes it possible, on the one hand, to achieve a desired elasticity. On the other hand, a sufficient stability may be ensured over the service life. The layer construction also ensures that the stability required for absorbing the retention forces is always guaranteed.

It is also advantageous, however, that the first contact surface is developed on a metallic layer, that the second contact surface is developed on a metallic layer and that at least one gap is provided between the metallic layer, on which the first contact surface is developed, and the metallic layer on which the second contact surface is developed. A direct transmission of vibrations between the metallic layer, on which the first contact surface is developed, and the metallic layer, on which the second contact surface is developed, is thus prevented. At least one elastic layer is therefore within the transmission path. This results in a desired vibration damping and consequently in a noise reduction. The gap is advantageously developed on the connecting web. In particular, the metallic layers on the arms of the base body may thereby be developed in a full-faced manner in order to form large and uniform contact surfaces.

It is also advantageous, however, that the first contact surface is developed on an elastic layer, which is provided on the first arm, that the second contact surface is developed on an elastic layer, which is provided on the second arm, and that an elastic layer is provided on a connecting web of the base body, which faces an area between the first arm and the second arm. In this development, at least the elastic layers on the first contact surface and the second contact surface are within the force transmission path. This makes it possible in particular to prevent, by way of construction, a direct transmission of vibrations via a metallic layer. Another option for noise damping is thus obtained.

The base body advantageously may be designed to be C-shaped. The base body may furthermore be designed to be plate-shaped. A C-shaped and plate-shaped development results in a lower space requirement and thus in an broad installability as well as a simple manufacturability.

### BRIEF DESCRIPTION OF THE DRAWINGS

FIG. 1 a fuel injection system having a connecting element corresponding to a first exemplary embodiment of the present invention and an internal combustion engine in an excerpted, schematic sectional view;

FIG. 2 a connecting element of the fuel injection system shown in FIG. 1 according to a second exemplary embodiment of the invention in a schematic sectional view and

FIG. 3 a connecting element of the fuel injection system shown in FIG. 1 according to a third exemplary embodiment in a schematic sectional view.

### DETAILED DESCRIPTION

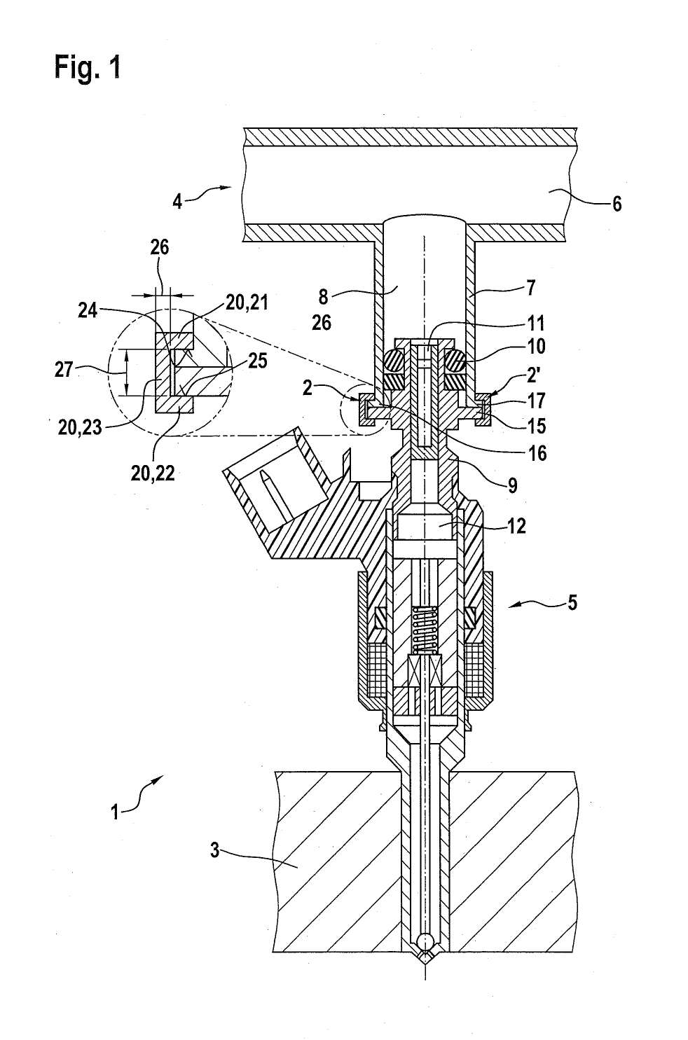

FIG. 1 shows a fuel injection system 1 having a connecting element 2 corresponding to a first exemplary embodiment and an internal combustion engine 3 in an excerpted, schematic sectional view. In this exemplary embodiment, fuel injection system 1 has a fuel-carrying component 4, which is designed as a fuel distributor rail 4. Fuel injection system 1 may be particularly used for high-pressure injection in internal combustion engines 3. In particular, fuel injection system 1 may be used in mixture-compressing internal combustion engines 3 having externally supplied ignition. Connecting element 2 is particularly suitable for such a fuel injection system 1. For this purpose, fuel distributor rail 4 is able to store fuel at high pressure and distribute it to multiple fuel injectors 5, of which only fuel injector 5 is shown in FIG. 1 for the sake of simplifying the representation.

Fuel distributor rail 4 has an elongated fuel chamber 6, via which fuel may be conveyed into a cup 7 provided on fuel distributor rail 4. A fuel fitting 9 of fuel injector 5 is inserted into an interior 8 of cup 7. A sealing element 10 is disposed between fuel fitting 9 and cup 7, which is developed as an O-shaped sealing element 10. Fuel may be conveyed through it from interior 8 via an inflow-side end 11 of fuel fitting 9 into an interior 12 of fuel injector 5.

Fuel fitting 9 has a circumferential collar 15. At one end 16, cup 7 furthermore has an outer circumferential flange 17. When fuel injector 5 in the installed state is inserted with its fuel fitting 9 into cup 7, then circumferential collar 15 of fuel fitting 9 abuts against circumferential flange 17 of cup 7. Depending on the application, another element, in particular an annular element, may also be disposed between circumferential collar 15 and circumferential flange 17.

Fuel fitting 9 of fuel injector 5 is connected to cup 7 of flue distributor rail 4 via one or multiple connecting elements 2, 2′. Two connecting elements 2, 2′ are shown in FIG. 1. The development of connecting elements 2, 2′ is described in more detail in the following with reference to connecting element 2. Depending on the respective application, differently developed connecting elements 2, 2′ may also be used. Preferably, however, identically developed connecting elements 2, 2′ are used in a specified number, it also being possible that only one single connecting element 2 is used.

Connecting element 2 has a bracket-shaped base body 20. Base body 20 includes a first arm 21, a second arm 22 and a connecting web 23. First arm 21 and second arm 22 are connected to each other via connecting web 23. A first contact surface 24 is provided on first arm 21, which is developed in this exemplary embodiment on first arm 21. Furthermore, a second contact surface 25 is provided on second arm 22, which is developed in this exemplary embodiment on second arm 22.

First arm 21 of base body 20 on the one side engages behind circumferential flange 17 at end 16 of cup 7. Second arm 22 of base body 20 on the other side engages behind circumferential collar 15 of fuel fitting 9. In operation, fuel fitting 9 has the pressure of the fuel applied to it in the direction of internal combustion engine 3. A force thereby acts on fuel fitting 9, which presses circumferential collar 15 of fuel fitting 9 away from circumferential flange 17 of cup 7.

In operation, circumferential collar 15 of fuel fitting 9 is thus pressed against second contact surface 25 on second arm 22. First arm 21 accordingly is supported on its first contact surface 24 by circumferential flange 17 of cup 7. This is functionally equivalent to circumferential flange 17 being pressed against first contact surface 24 on first arm 21.

At least in operation, base body 20 thus abuts on its first contact surface 24 on the one side against cup 7 and on the other side on its second contact surface 25 against fuel injector 5. In the process, base body 20 is on the one side connected in a form-locking manner to cup 7 of fuel distributor rail 4 and on the other side in a form-locking manner to fuel injector 5.

In this exemplary embodiment, base body 20 is developed in such a way that an elastic decoupling is provided between first contact surface 24 of first arm 21 and second contact surface 25 of second arm 22. In this instance, the entire base body 20 is preferably developed to be elastically deformable. The stiffness required for decoupling may be achieved by an appropriately designed geometry of base body 20 and/or a suitable selection of a material for the base body. The geometry desired for achieving the stiffness may be influenced in particular by a cross-sectional area 26 and a length 27 of connecting web 23. A material based on a plastic in particular may be used as a material for base body 20.

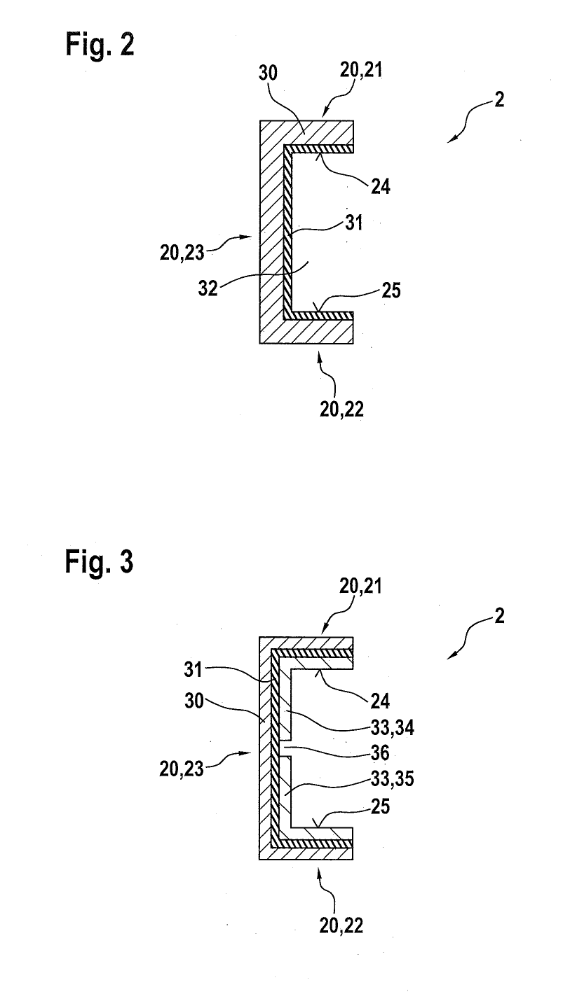

FIG. 2 shows a connecting element 2 of fuel injection system 1 shown in FIG. 1 according to a second exemplary embodiment in a schematic sectional view. In this exemplary embodiment, base body 20 is made of multiple layers 30, 31. Two layers 30, 31 are provided in this exemplary embodiment. Depending on the respective application, a greater number of layers 30, 31 may also be provided. Layer 30 is developed as metallic layer 30. Layer 31 is developed as elastic layer 31.

In this exemplary embodiment, elastic layer 31 extends across the entire base body 20, that is, from first arm 21 across connecting web 23 to second arm 22. Elastic layer 31 on connecting web 23 in this case faces an area 32 between first arm 21 and second arm 22.

In this exemplary embodiment, first contact surface 24 is developed on elastic layer 31, which is provided on first arm 21. Furthermore, second contact surface 25 is developed on elastic layer 31, which is provided on second arm 22. First arm 21 thus abuts against circumferential flange 17 of cup 7 via elastic layer 31. Furthermore, second arm 22 abuts with elastic layer 31 against circumferential collar 15 of fuel fitting 9. This results in a soft coupling of fuel injector 5 to fuel distributor rail 4.

Elastic layer 31 may be developed by coating metallic layer 30. Elastic layer 31 may be formed from an elastomer for example.

FIG. 3 shows a connecting element 2 of fuel injection system 1 shown in FIG. 1 according to a third exemplary embodiment in a schematic sectional view.

In this exemplary embodiment, base body 20 has layers 30, 31, 33. Layer 33 is in this case divided into layers 34, 35. The division of layer 33 into layers 34, 35 occurs by a gap 36. Gap 36 is developed in this exemplary embodiment as recess 36. Gap 36 is developed in this instance on connecting web 23.

Layer 33 is developed as metallic layer 33. Metallic layers 34, 35 are thus obtained. First contact surface 24 is developed on metallic layer 34. Second contact surface 25 is developed on metallic layer 35. A high resistance, especially with respect to mechanical stresses, is thus ensured on contact surfaces 24, 25. Furthermore, gap 36 prevents a direct transmission of vibrations between contact surfaces 24, 25 via the metallic layer, because gap 36 is provided.

An effective damping of vibrations is thereby obtained. Depending on the respective application, a development having a plurality of metallic layers and a plurality of elastic layers is also possible, it being possible for a gap 36 developed as recess 36 for example to be several layers deep. Specifically, base body 20 may be formed from a sandwich sheet metal, in which metallic layers, in particular made of steel, and elastic layers, in particular made of an elastomer, alternate in the layer structure. Instead of the elastomer, other soft materials may also be used for developing elastic layer 31 or multiple such elastic layers 31.

In particular, base body 20 may thus be developed in a C-shaped and plate-shaped manner.

The plate-shaped development here refers to a depth of base body 20, which is perpendicular to the drawing plane chosen in FIGS. 1 through 3.

Connecting element 2 may thus be implemented having damping properties. It is thus possible to reduce the transmittable structure-borne noise energy. In particular, a decoupling or isolation of fuel injector 5 with respect to fuel distributor rail 4 may be achieved as a result.

The present invention is not limited to the exemplary embodiments described.

What is claimed is:

1. A connecting element for a fuel injection system for connecting a fuel injector to a fuel-carrying component, comprising:
a base body which, on one side, is able to be connected in a form-locking manner to the fuel-carrying component and, on another side, is able to be connected in a form-locking manner to the fuel injector, wherein:
the base body includes a bracket-shaped base body,
the base body includes a first arm and a second arm,
the base body abuts on a first contact surface provided on the first arm, on the one side at least indirectly against the fuel-carrying component, and abuts on a second contact surface provided on the second arm, on the other side at least indirectly against the fuel injector; and
an elastic decoupling provided between the first contact surface and the second contact surface.

2. The connecting element as recited in claim 1, wherein:
the base body includes a connecting web, and
the first arm and the second arm are connected to each other via the connecting web.

3. The connecting element as recited in claim 2, wherein at least one of the first arm of the base body, the second arm of the base body, and the connecting web of the base body is formed at least partially from an elastic material.

4. The connecting element as recited in claim 2, wherein at least one of the first arm of the base body, the second arm of the base body, and the connecting web of the base body is formed from multiple layers, at least a portion of the layers being formed from an elastic material.

5. The connecting element as recited in claim 4, wherein another portion of the layers is formed from a metallic material.

6. The connecting element as recited in claim 4, wherein:
the first contact surface is developed on a first metallic layer,
the second contact surface is developed on a second metallic layer, and
at least one gap is provided between the first metallic layer and the second metallic layer.

7. The connecting element as recited in claim 6, wherein the gap is provided on the connecting web.

8. The connecting element as recited in claim 4, wherein at least one of:
the first contact surface is developed on an elastic layer provided on the first arm,
the second contact surface is developed on the elastic layer provided on the second arm, and
the elastic layer is provided on the connecting web of the base body, which faces an area between the first arm and the second arm.

9. A fuel injection system, comprising:
at least one fuel-carrying component;
at least one fuel injector; and
at least one connecting element, the fuel injector being connected to the fuel-carrying component via the at least one connecting element, the at least one connecting element including:
a base body which, on one side, is able to be connected in a form-locking manner to the fuel-carrying component and, on another side, is able to be connected in a form-locking manner to the fuel injector, wherein:
the base body includes a bracket-shaped base body,
the base body includes a first arm and a second arm,
the base body abuts on a first contact surface provided on the first arm, on the one side at least indirectly against the fuel-carrying component, and abuts on a second contact surface provided on the second arm, on the other side at least indirectly against the fuel injector; and
an elastic decoupling provided between the first contact surface and the second contact surface.

10. The fuel-injection system as recited in claim 9, wherein the fuel injection system is for a mixture-compressing internal combustion engine having an externally supplied ignition.

11. The fuel-injection system as recited in claim 9, wherein the fuel injector is connected to the fuel-carrying component via multiple connecting elements.
